(19) United States
(12) Patent Application Publication
(10) Pub. No.: US 2023/0136263 A1
(43) Pub. Date: May 4, 2023

(54) PLANNING METHOD OF DEPLOYING OPERATING STATION

(71) Applicant: LSC ECOSYSTEM CORPORATION, Taoyuan City (TW)

(72) Inventors: Wei-Ming LI, Taoyuan City (TW); Kuan-Hsun CHO, Taoyuan City (TW); Sung-Ching LIN, Taoyuan City (TW)

(21) Appl. No.: 17/742,829

(22) Filed: May 12, 2022

(30) Foreign Application Priority Data
Oct. 28, 2021 (TW) 110140087

(51) Int. Cl. G06Q 10/06; G01C 21/34

(52) U.S. Cl. CPC G06Q 10/06313; G01C 21/3453; B60L 53/00

(57) ABSTRACT

A planning method of deploying an operating station is provided. The planning method includes a data pre-process procedure, a service area group (SAG) generating procedure and a station selecting procedure. The data pre-process procedure is configured to at least obtain a station information of multiple potential stations and a target-object distribution data. The SAG generating procedure is configured to calculate a shortest route between any two potential stations and a service area (SA) of each potential station and plans the multiple potential stations into multiple SAGs based on the shortest routes and the SAs. The station selecting procedure is configured to set a requested deployment number for each SAG based on an estimated target object number covered by each SAG.

### BACKGROUND OF THE DISCLOSURE

### Technical Field

The disclosure relates to an operating station of a vehicle or an operation machine, particularly relates to a planning method of deploying an operating station.

### Description of Related Art

Following the technological progress and rising of environmental awareness, all kinds of electric vehicles are gradually universalized.

Regarding the electric vehicle, the most important issue is convenience of energy service, such as recharging, replacing battery, etc. Therefore, the arrangement of the operating station, such as charging station/battery station, is important. How to select the most proper location to deploy appropriate number of charging station or battery station under limited budget is an art for the planner or deployer of the station.

Many station evaluation methods and systems are already developed in the related art. For example, some station evaluation systems are configured to analyze the geographic information of specific district through the geographic information system (GIS). After the proper location for deploying charging station or battery station is found, the deployer heads to the location to perform deployment operation for the station.

However, the aforementioned method directly determines the station without priorly filtering the location with respect to the circumstance, and that may cause the difficulty of the following construction (for example, the owner of the location does not agree, or population around the location is scarce and unfavorable for operation or utilization efficiency, etc.) for the deployer.

Moreover, some station evaluation systems are configured to abundantly analyze operation model and data of known vehicles, charging stations or battery stations to perform analyzation and evaluation, thereby outputting the suggested deploying location of new station. However, the aforementioned method is not practical for the company without operation model or practical operation data.

Apart from the deployment operation of the charging station/battery station for the electric vehicle, the deployment planning of the operating stations for all kinds of operation machines, machinery tools, ships, aircraft, etc., with respect to the operation content may also face the same issues.

In view of this, the inventors have devoted themselves to the aforementioned related art, researched intensively try to solve the aforementioned problems.

### SUMMARY OF THE DISCLOSURE

The main object of the disclosure is to provide a planning method of deploying an operating station, which may analyze and evaluate a plurality of known and deployable potential stations based on the data, such as traffic route between the stations, number of the target service object, etc., to select the operating station of proper number and satisfying the needs.

To achieve the object, the planning method of the disclosure includes a data pre-process procedure, a service area group (SAG) generating procedure and a station selecting procedure. The data pre-process procedure is configured to at least obtain a station information of a plurality of potential stations and a target-object distribution data. The SAG generating procedure is configured to calculate a shortest route between any two potential stations and a service area (SA) of each potential station and plans the a plurality of potential stations into a plurality of SAGs based on the shortest routes and the SAs.

The station selecting procedure is configured to set a requested deployment number for each SAG based on an estimated target object number covered by each SAG.

The technical effects of the disclosure comparing to the related art are as below. The most proper operating stations may be automatically analyzed and determined based on the information, such as the shortest routes between a plurality of potential stations, SA of each potential station, and target object number being covered, etc. As a result, the highest coverage rate for the target objects may be acquired under the premise of being most satisfied with the cost, thereby greatly increasing the utilization efficiency of the deployed operating stations.

### BRIEF DESCRIPTION OF THE DRAWINGS

FIG. 1 is a block diagram of the planning method of the disclosure in accordance with some embodiments.

FIG. 2 is a flowchart of the planning method of the disclosure in accordance with some embodiments.

FIG. 3 is a flowchart of the data pre-process procedure of the disclosure in accordance with some embodiments.

FIG. 4 is a flowchart of generating the SAG of the disclosure in accordance with some embodiments.

FIG. 5 is a schematic diagram of the shortest route of the disclosure in accordance with some embodiments.

FIG. 6 is a schematic diagram of the SA of the disclosure in accordance with the first embodiment.

FIG. 7 is a schematic diagram of the SA of the disclosure in accordance with the second embodiment.

FIG. 8 is a schematic diagram of the overlapping area of the disclosure in accordance with some embodiments.

FIG. 9 is a schematic diagram of the SAG of the disclosure in accordance with some embodiments.

FIG. 10 is a flowchart of selecting the station of the disclosure in accordance with some embodiments.

FIG. 11 is a schematic diagram of the station number of the disclosure in accordance with some embodiments.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

The disclosure provides a planning method of deploying an operating station (hereafter as the planning method). The planning method is used to analyze and evaluate the known and deployable potential stations, such as charging stations, battery stations, processing stations, maintenance stations, gas stations, observation stations, etc., in the target area to select the most proper operating stations. In the practical deployment, the deployer may perform practical construction for the operating stations, such as charging stations, battery stations, processing stations, maintenance stations, gas stations, observation stations, etc., according to the operating stations provided by the planning method. As a result, the number of the constructed operating stations may be satisfied with the cost requirement of the planner or deployer, and further the estimated target object number to be served of the constructed operating stations may achieve required efficiency.

For example, after a field trip is made to the target area, the planner or deployer may discover five hundred, seven hundred, or one thousand potential stations. The potential station indicates the location where the geographic environment meets the requirement (for example, electricity is available), the owner is willing to cooperate with the planner or deployer, or the location is rentable or buyable, etc. On the other hand, based on the budget consideration, the planner or deployer may only be able to arrange fifty operating stations. The technical solution of the disclosure may support the planner or deployer to find the operating stations, which is most satisfied with the needs, from all of the potential stations to make the operating stations achieve the object of maximizing operation efficiency.

Taking the target area as the target district for an example, the operating station may be, for example, the charging station or battery station for the electric vehicles, or the maintenance station for specific machines or devices.

The aforementioned description is part of the embodiments of the disclosure, here is not intended to be limiting.

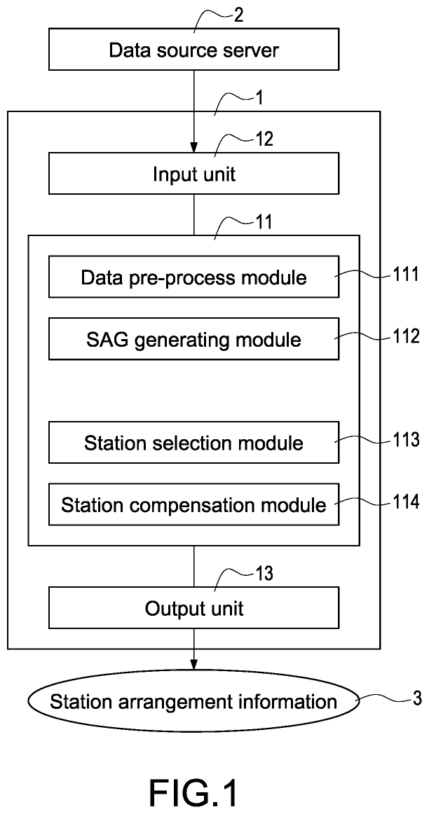

Please refer to FIG. 1, which is a block diagram of the planning method of the disclosure in accordance with some embodiments. The planning method of the disclosure is implemented through the deployment planning system (hereafter as the planning system 1) of the operating station. As shown in FIG. 1, the planning system 1 may include a processing unit 11, an input unit 12 and an output unit 13 both connected with the processing unit 11. The processing unit 11 at least includes a data pre-process module 111, a service area group (SAG) generating module 112, and a station selection module 113 based on the functions that the planning system 1 needs to carry out, here is not intended to be limiting.

The input unit 12 may be a human-machine interface (HMI, for example, keyboard, mouse, touch pad, etc.), a wired transmission interface (for example, USB port), or a wireless transmission interface (for example, Wi-Fi transmission unit, Bluetooth transmission unit, etc.). The planning system 1 may be configured to receive all kinds of data required for executing the planning method through the input unit 12.

In some embodiments, the planning system 1 may be configured to receive configuration of the target area (for example, the target district such as the designated county, city, township, the target sea area such as the designated river, ocean, and the target airspace such as the sky of the designated location or coordinated position) for analyzing and input of a plurality of known and deployable potential stations in the target area from the planner through the input unit 12.

In some other embodiments, the planning system 1 may be connected to the data source server 2 through the input unit 12 to receive the data required for analyzation therefrom, for example, the transportation network data, target-object distribution data, land use data, traffic signal data (such as the deployment data of the traffic light), etc., here is not intended to be limiting.

In some embodiments, the a plurality of modules 111-114 in the processing unit 11 may be hardware modules. For example, each module 111-114 may be carried out by the processor, micro control unit (MCU), field programmable gate array (FPGA), or system on chip (SoC), etc.

In some other embodiments, the processing unit 11 may be the processor, central processing unit (CPU), graphic processing unit (GPU), or MCU, and the a plurality of modules 111-114 in the processing unit 11 may be software modules. In some embodiments, the processing unit 11 is configured to record a computer executable code, when the processing unit 11 executes the computer executable code, the processing unit 11 is configured to virtually simulate the computer executable code to be the a plurality of modules 111-114 (for example, the modules 111-114 are corresponding to the sub-programs in the computer executable code respectively) according to the achievable functions. The aforementioned description is part of the embodiments of the disclosure, here is not intended to be limiting.

The output unit 13 may be a wired transmission interface, a wireless transmission interface, or a display device, here is not intended to be limiting. The planning method of the disclosure mainly selects the operating stations satisfied with the needs from the potential stations according to the data, such as the geographic information, target object number (for example, population to be served, equipment number to be repaired, marine litter number to be collected, fish number to be caught, bird number to be observed, etc.), area category, etc., of the target area. When the selection is completed, the planning system 1 may be configured to output the station arrangement information 3 through the output unit 13. The station arrangement information 3 may include text information or image information of the operating stations, the deployer may practically construct the operating stations based on the station arrangement information 3 (detailed as follows).

For the application on the land, the planning method of the disclosure may be used to plan the charging station/battery station of the electric vehicle, or the operating station for the other energy service. Specifically, the planning method of the disclosure may select the operating stations satisfied with the needs from the potential stations according to the geographic information, population, area category of the target area. When the selection is completed, the planning system 1 is configured to output the station arrangement information 3 through the output unit 13. Therefore, the deployer may practically construct the charging station/battery station based on the station arrangement information 3.

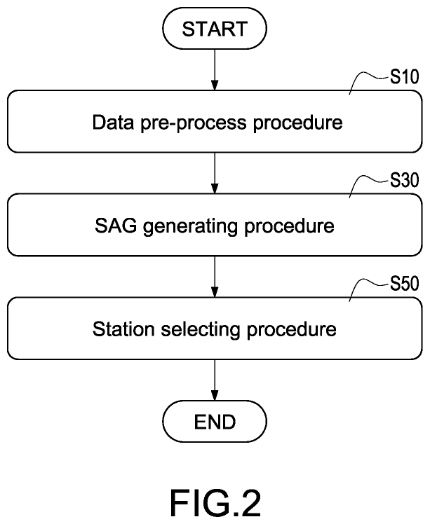

Please refer to FIG. 2, which is a flowchart of the planning method of the disclosure in accordance with some embodiments. As shown in FIG. 2, the planning method of the disclosure includes a data pre-process procedure (step S10), a SAG generating procedure (step S30) and a station selecting procedure (step S50).

The data pre-process procedure is mainly used to obtain the necessary information required for selecting the operating stations, and transform the information into the data format capable of being used by the planning system 1. The SAG generating procedure is used to cluster (or group) all of the potential stations according to the obtained necessary information to generate a plurality of SAGs satisfied with the preset conditions. The station selecting procedure is used to filter one or a plurality of potential stations in each SAG to select zero, one, or more than one operating stations from each SAG. After the step S50, the planning system 1 may be configured to output the station arrangement information 3 based on all of the operating stations being selected.

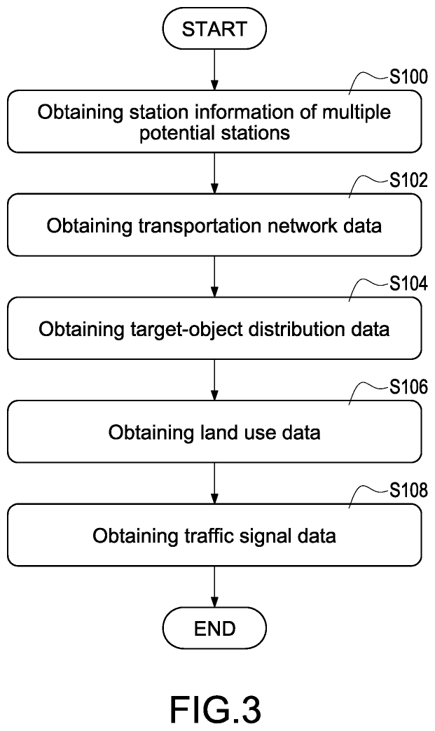

Please refer to FIG. 1 to FIG. 3, FIG. 3 is a flowchart of the data pre-process procedure of the disclosure in accordance with some embodiments. FIG. 3 is used for specifying the data pre-process procedure (step S10) in FIG. 2.

As shown in FIG. 3, for deployment planning of the operating stations, the planning system 1 of the disclosure is configured to obtain the station information of a plurality of potential stations through the data pre-process module 111 in advance. For example, the data pre-process module 111 may be configured to receive the station information of the potential stations, which is directly input by the planner, through the input unit 12, and perform the data pre-process action to the station information. In some embodiments, the station information may be, for example, the number of the potential stations and the address or coordinate of each potential station in the geographic information.

It is worth mentioning that the planner or deployer in the disclosure may configure the target area in the planning, and the potential stations are respectively located inside the target area configured by the planner or deployer. In some embodiments, the target area is the target district, for example, county, city, or township, etc., here is not intended to be limiting. In some other embodiments, the target area may be the target sea area or target airspace, here is not intended to be limiting.

Further, the planning system 1 is configured to obtain the transportation network data related to the target area through the data pre-process module 111 (step S102). For example, the data pre-process module 111 may be configured to receive the transportation network data from the data source server 2 through the input unit 12, and perform the data pre-process action to the transportation network data. In some embodiments, the transportation network data records (includes) all of the drivable routes (or sailable route, flyable route, hereafter collectively indicates as drivable route) around each potential station, that is, all of the passable routes departed from each potential station.

For example, if the planning system 1 is used to plan the operating station on the land, the transportation network data may be the traffic information on the land, and the data pre-process module 111 may be configured to receive the traffic information on the land from the official national land surveying and mapping database through the input unit 12. For example, the transportation road network data of the national land surveying and mapping database.

In some embodiments, the planning method of the disclosure may be used to plan the deployment for the charging station or battery station of all kinds of electric vehicles (for example, the electric motorcycle or electric car used on the land, electric drone used in the air, electric boat used on the sea, etc.), here is not intended to be limiting.

In the step S102, the planning system 1 may be configured to perform the data pre-process to the transportation network data according to the target vehicle category of the planning procedure. For example, if the target vehicle category of the planning procedure is the electric motorcycle on the land, the planning system 1 may be configured to solely reserve information of the drivable road for the electric motorcycle in the step S102. For another example, if the target vehicle category of the planning procedure is the electric boat on the sea, the planning system 1 may be configured to solely reserve information of the sailable fairway for the electric boat in the step S102. For another example, if the target vehicle category of the planning procedure is the electric drone in the air, the planning system 1 may be configured to solely reserve information of the flyable routes for the electric drone in the step S102.

The aforementioned description is part of the embodiments of the disclosure, here is not intended to be limiting.

Further, the planning system 1 may be configured to obtain the target-object distribution data related to the target area through the data pre-process module 111 (step S104).

For example, if the planning system 1 is used to plan the operating station on the land, the target area may be the target district, and the target-object distribution data is the population distribution data. In some embodiments, the data pre-process module 111 may be configured to receive the population distribution data from the data source server 2 (for example, the official database of the statistics department) through the input unit 12, and perform the data pre-process to the population distribution data. It is worth mentioning that when the population distribution data is obtained, the planner or deployer may select different population statistics unit according to the category rule of the database, for example, first-level dissemination area, second-level dissemination area, third-level dissemination area, etc., to obtain the population distribution data in different precision from the data source server 2.

In some embodiments, the planning method of the disclosure may be used to perform the planning action of a plurality of operating stations to the target area through the potential stations, transportation network data, and target-object distribution data. To further satisfy the requirement from the planner and the user in the target area regarding the number and locations of the operating stations being planned, the planning method of the disclosure may further consider the other information.

As shown in FIG. 3, the planning system 1 may be configured to obtain the land use data related to the target area through the data pre-process module 111 (step S106).

For example, if the planning system 1 is used to plan the operating station on the land, the target area may be the target district, and the land use data may be the national land use investigation data. In some embodiments, the data pre-process module 111 may be configured to receive the national land use investigation data from the data source server 2 (for example, the official national land surveying and mapping database) through the input unit 12 and perform the data pre-process to the national land use investigation data. The national land use investigation data records a plurality of land use category in the target area, for example, agricultural land use, transportation land use, water conservancy land use, building land use, etc., here is not intended to be limiting.

The planning method of the disclosure may filter the target-object distribution data obtained in the step S104 through the utilization of the land use data to affirmatively select the operating stations with higher utilization efficiency.

For example, if the user for the operating station in the planning procedure is delivery person and/or courier on the land, the planning system 1 may be configured to search the building land (for example, the commercial building, composite building, residential building, etc.) in the target area by the national utilization data, and solely reserve the population (that is, the target object number) in the building land when calculating the population. As a result, the selected operating station may cover more using population when the planning method is used to select the operating station based on the filtered population distribution data.

The planning system 1 may be configured to further obtain the traffic signal data related to the target area through the data pre-process module 111 (step S108).

For example, the data pre-process module 111 may be configured to receive the traffic signal data from the data source server 2 (for example, the OpenStreetMap (OSM) database) through the input unit 12 and perform the data pre-process to the traffic signal data. The traffic signal data records the data, such as the locations of all the traffic signals, peak waiting time, off-peak waiting time, etc., in the target area, here is not intended to be limiting. Taking land as an example, the traffic signal may be the traffic light.

The planning system 1 may be configured to calculate the waiting cost (including the number of the traffic signal that needs to be passed and estimated waiting time, etc.) for back-and-forth between the operating stations through the traffic signal data after the station arrangement information 3 is generated. Therefore, the planning system 1 may be configured to perform analyzation to the utilization efficiency of the selected operating stations and further optimize the station arrangement information 3.

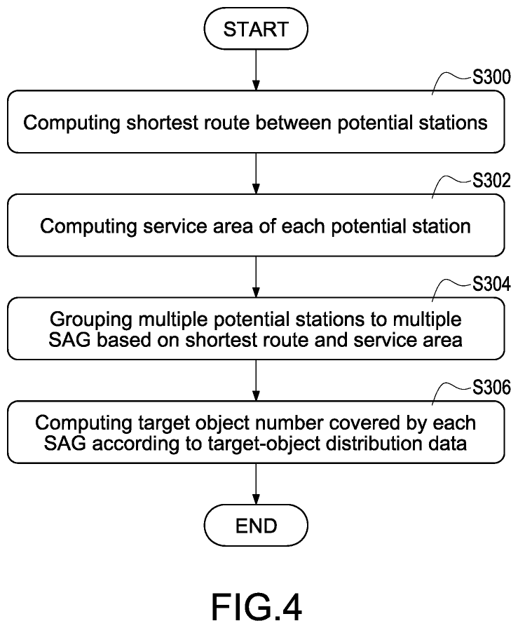

Please refer to FIG. 1 to FIG. 4, FIG. 4 is a flowchart of generating the SAG of the disclosure in accordance with some embodiments. FIG. 4 is used for specifying the SAG generating procedure (step S30) in FIG. 2.

As shown in FIG. 4, in the SAG generating procedure, the planning system 1 is configured to receive the station information and transportation network data being pre-processed through the SAG generating module 112 in advance, thereby calculating the shortest routes between any two potential stations (step S300). Specifically, in the step S300, the SAG generating module 112 is configured to obtain all of the connecting routes between any two potential stations according to the transportation network data, and select the route with the shortest distance.

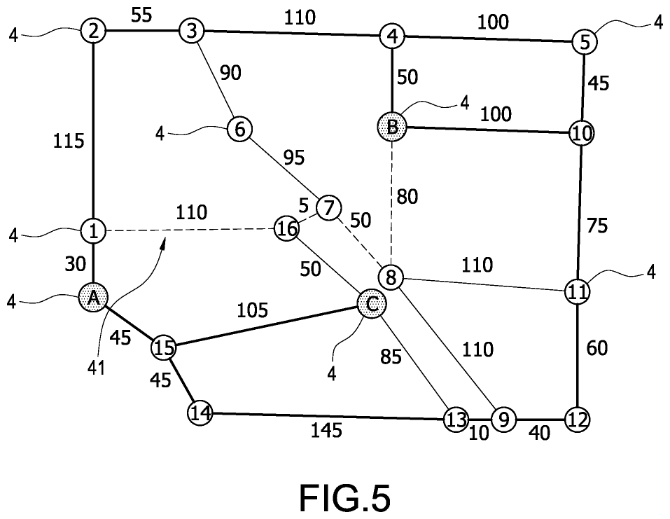

Please refer to FIG. 5, which is a schematic diagram of the shortest route of the disclosure in accordance with some embodiments. As shown in FIG. 5, the SAG generating module 112 is configured to obtain all of the potential stations 4 in the target area, and compute the shortest routes 41 between the potential stations 4.

The embodiment in FIG. 5 uses the potential station “1” to the potential station “16”, the potential station “A”, the potential station “B”, and the potential station “C” as an example, but the arrangement manner and number of the potential stations 4 are not limited to FIG. 5. In the FIG. 5, the shortest distance between the potential station “1” and the potential station “2” is about 115 meters, and the shortest distance between the potential station “2” and the potential station “3” is about 55 meters, and so forth.

Further, the shortest route 41 in the disclosure is not limited to the route directly connecting two potential stations 4. The shortest route 41 may include the route between any two arbitrary potential stations 4. For example, a plurality of routes are existed between the potential station “A” and the potential station “B” (such as, A→1→2→3→4→B, A→1→16→7→8→B, A→1→2→3→6→7→8→B, A→15→C→16→7→8→B, etc.). The shortest route 41 in the disclosure indicates the route with the shortest distance among the a plurality of routes between any two arbitrary potential stations 4.

In some embodiments, the shortest route 41 between the potential station “A” and the potential station “B” is the sum of the shortest route 41 between the potential station “A” and the potential station “1” (that is 30 meters), the shortest route 41 between the potential station “1” and the potential station “2” (that is 115 meters), the shortest route 41 between the potential station “2” and the potential station “3” (that is 55 meters), the shortest route 41 between the potential station “3” and the potential station “4” (that is 110 meters), and the shortest route 41 between the potential station “4” and the potential station “B” (that is 50 meters), which is 360 meters. The aforementioned description is part of the embodiments of the disclosure, here is not intended to be limiting.

For better understanding, each shortest route 41 in the FIG. 5 is indicated by the linear distance between two potential stations 4. On the other hand, as described above, the SAG generating module 112 is configured to search the shortest route 41 based on the transportation network data, and thus the shortest route 41 is corresponding to the practical roads recorded in the geographic information and may not be a straight line.

Referring back to FIG. 4, apart from computing the shortest route 41, the SAG generating module 112 may be configured to further compute the service area (SA) of each potential station 4 according to the preset evaluation condition (step S302).

In some embodiments, the evaluation condition may be, for example, a fixed radius. In some embodiments, the SAG generating module 112 is configured to use each potential station 4 as the center in the step S302, virtually generate a full circle based on the center and radius and take the area of the full circle as the SA of each potential station 4.

Takin the electric motorcycle as an example, if the electric motorcycle travels three minutes at the speed of 40 kilometers per hour, the estimated distance is about two kilometers. If the planner or deployer estimates the aforementioned traveling time and traveling time is acceptable cost of replacing battery/charging for the user, the evaluation condition may be configured to the radius of 2 kilometers. Taking the fishing boat as an example, the traveling speed of the fishing boat is slower, and thus the planner or deployer may configure the evaluation condition to be the radius of one kilometer after evaluating.

In some other embodiments, the evaluation condition may be a fixed moving distance or fixed moving time. For example, the moving distance may be two kilometers, the moving time may be three minutes with the speed of 40 kilometers per hour, here is not intended to be limiting.

In some embodiments, the SAG generating module 112 is configured to take each potential station 4 as the starting point, and compute one or a plurality of boundary positions, which may be arrived by a moving distance or traveling time from the potential station 4 along every drivable route indicated in the transportation network data. Further, the SAG generating module 112 is configured to perform the convex hull computation according to the boundary positions to generate the vehicle capability-based service area (VCSA) of each potential station 4.

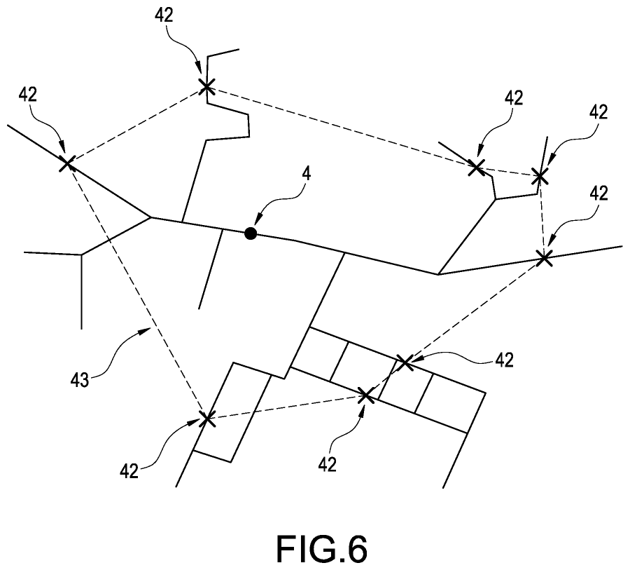

Please refer to FIG. 6, which is a schematic diagram of the SA of the disclosure in accordance with the first embodiment. As described above, the transportation network data records (includes) all the drivable routes around each potential station 4. In some embodiments, the SAG generating module 112 is configured to compute all of the drivable routes around each potential station 4 based on the preset evaluation condition, and set all of the routes satisfied with the evaluation condition to be the crucial routes (for example, the distance is more than two kilometers, or the moving time is more than three minutes with the speed of 40 kilometers per hour), and further set one or a plurality of vertices satisfied with the evaluation condition to be the boundary positions 42 on the crucial routes.

The embodiment in FIG. 6 uses the route on the land as an example. In some other embodiments, the drivable route may also be understood as the sailable fairway on the sea or flyable routes in the air and is not limited to the embodiment in FIG. 6. For better understanding, hereafter uses the route on the land as the example for explanation.

The SAG generating module 112 is configured to perform the convex hull computation to all the boundary positions 42 to generate the SA 43 of the potential station 4. As shown in FIG. 6, the directions and shapes of all crucial routes are different and the linear distances between each boundary position 42 and potential station 4 are also different, and thus the SA 43 may not be a full circle.

It worth mentioning that the SAG generating module 112 of the embodiment is configured to regard one or a plurality of routes, which are satisfied with the aforementioned moving distance or moving time, as the crucial route, and abandon the routes with ineligible distance (that is, shorter than required distance), which are not satisfied with the aforementioned moving distance or moving time for forming the boundary positions 42 accepted to the convex hull, after the computation.

In the embodiments of FIG. 4, FIG. 5, and FIG. 6, the SAG generating module 112 may be configured to compute the shortest route 41 and SA 43 through Dijkstra's algorithm, here is not intended to be limiting. Except Dijkstra's algorithm, in some other embodiments, the SAG generating module 112 may be configured to compute the shortest route 41 and SA 43 through Bellman-Ford algorithm, A* search algorithm, Floyd-Warshall algorithm, here is not intended to be limiting.

The detail of the algorithms is omitted here for brevity.

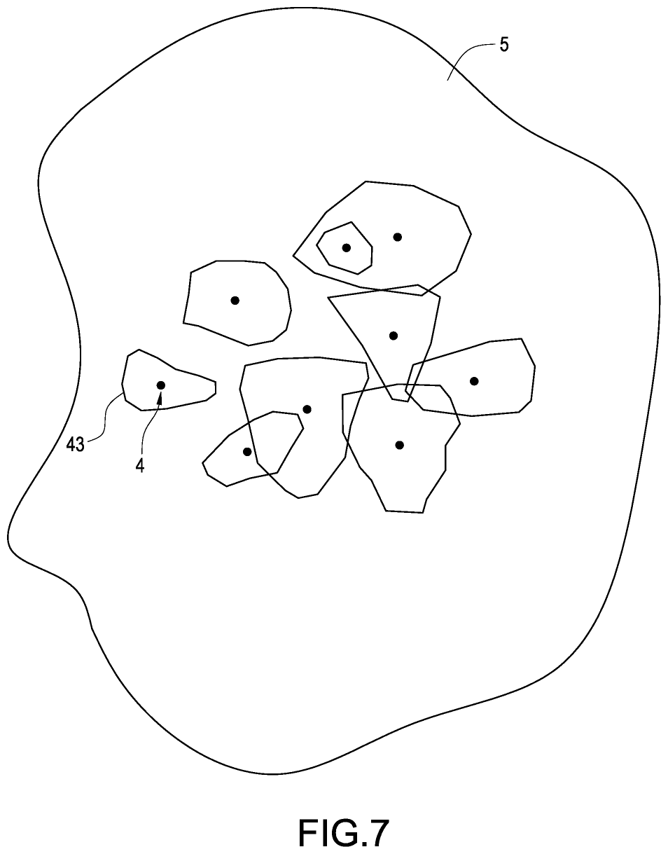

Please refer to FIG. 7, which is a schematic diagram of the SA of the disclosure in accordance with the second embodiment. As described above, the planning system 1 is configured to obtain the corresponding transportation network data and station information of the potential stations according to the target area 5. Therefore, after the step S302, the planning system 1 may acquire the distribution of the potential stations 4 in the target area 5 and the SA 43 of each potential station 4. As shown in FIG. 7, the SAs 43 of the potential stations 4 may separate from each other, partially overlap, or fully overlap with each other. In some embodiments, the SAG generating module 112 may be configured to plan and generate a plurality of SAGs according to the overlapping condition of the SAs 43.

Referring back to FIG. 4, it should be noted there is no sequential relation of executing the step S300 and the step S302. In some embodiments, the planning system 1 may be configured to execute the step S300 to compute the shortest route 41 between any two potential stations 4 in advance, and then execute the step S302 to compute the SA 43 of each potential station 4. In some other embodiments, the planning system 1 may be configured to execute the step S302 in advance, and then execute the step S300. Further, the planning system 1 may be configured to execute the step S300 and step S302 simultaneously through the multiplexing technology, and the sequence is not limited to that in FIG. 4.

After the step S300 and step S302, the SAG generating module 112 is configured to group the potential stations 4 to a plurality of SAGs based on the shortest routes 41 between the potential stations 4 and the SAs 43 of the potential stations 4 (step S304). Each SAG includes one or a plurality of different potential stations 4.

Specifically, in the step S304, the SAG generating module 112 is configured to execute the clustering algorithm (or unsupervised learning algorithm) based on the shortest routes 41 and SAs 43 to cluster (or group) the potential stations 4 and divide the potential stations 4 into the SAGs.

It is worth mentioning that the SAG generating module 112 mainly use average overlap rate (%) of the SAs 43 as the clustering target for the clustering algorithm. Taking hierarchical clustering algorithm for the clustering as an example, in some embodiments, the SAG generating module 112 is configured to make the average overlap rate of the SAs 43 of the potential stations 4 in each clustered SAG be the highest. In some other embodiments, the SAG generating module 112 is configured to make the average overlap rate of the SAs 43 of the potential stations 4 in each clustered SAG be greater than or equal to a preset boundary value.

In some embodiments, the SAG generating module 112 is configured to calculate the overlap rate of the SAs of the potential stations 4 in the SAG by formula (1) as below.

$${overlap}_{k} ( i ) ( \% ) = \frac{overlap area of {SAG}_{k} ( i )}{total SA of {SAG}_{k} ( i )} \qquad ( 1 )$$

The total SA of SAGₖ(i) indicates the total area of the SAs 43 of the potential stations 4 in the SAG. The overlap area of SAGₖ(i) indicates the overlap area of the SAs 43 of the potential stations 4 in the SAG. Overlapₖ(i)(%) indicates the overlap rate of the SAs 43 of the SAG.

In some embodiments, the SAG generating module 112 is configured to calculate the average overlap rate of the SAs of all SAGs in the target area by formula (2) as below.

$$average overlap rate ( \% ) = \frac{{\sum }_{i = 1}^{k} {overlap}_{k} ( i ) ( \% )}{k} \qquad ( 2 )$$

Average overlap rate (%) indicates the average overlap rate of the SAs of all SAGs (k in total) in the target area.

For example, the number of the potential stations 4 may be 800 in total. In the step S304, the SAG generating module 112 may be configured to iteratively execute the hierarchical clustering algorithm according to the shortest routes 41 to sequentially cluster the 800 potential stations 4 into 800 groups, 799 groups, 798 groups, . . . , 1 group. Further, the SAG generating module 112 is configured to respectively compute the overlap rate of the SAs 43 of one or a plurality of potential stations 4 in the groups according to formula (1), and compute the average overlap rate of the SAs 43 of all groups according to formula (2).

If a group with specific number (for example, 70) is confirmed to be planned after determination, the average overlap rate of the SAs 43 is the highest, or greater than or equal to the preset boundary value (for example, 70%), and the SAG generating module 112 may output the clustering result for the SAGs.

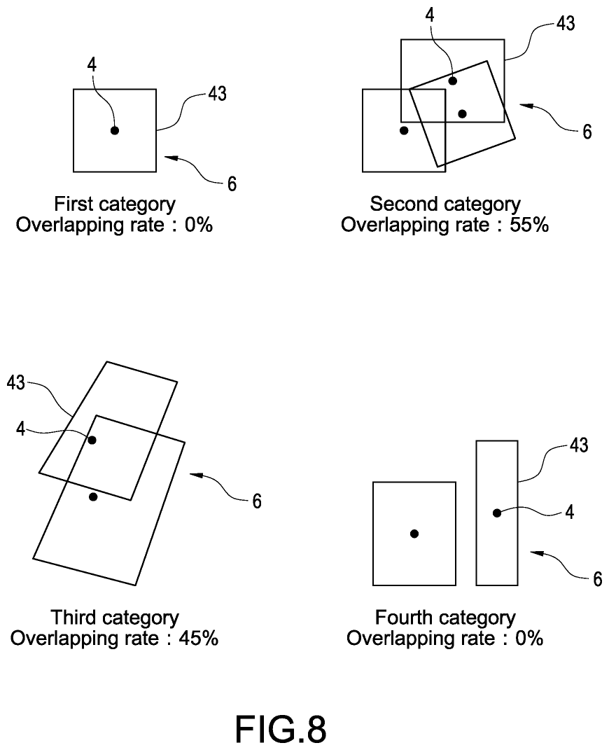

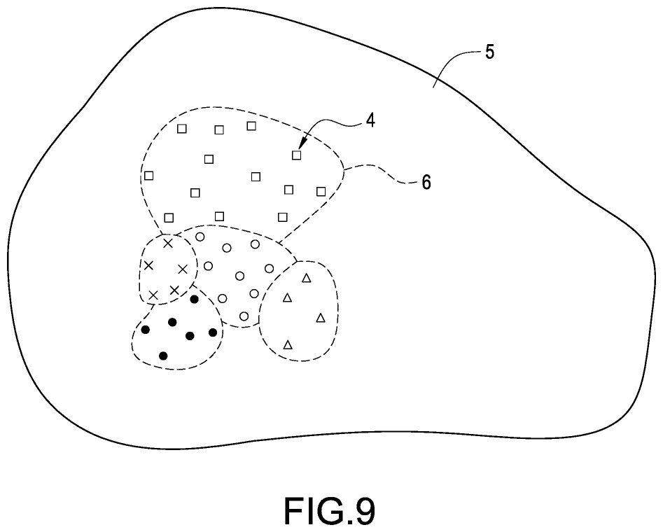

Please refer to FIG. 8 and FIG. 9, FIG. 8 is a schematic diagram of the overlapping area of the disclosure in accordance with some embodiments and FIG. 9 is a schematic diagram of the SAG of the disclosure in accordance with some embodiments.

As shown in FIG. 8, in the condition of first category, single potential station 4 assembles the SAG 6 by its own, and the overlap rate of the SA 43 is 0%. In the condition of second category, three potential stations 4 assemble the SAG 6, and the overlap rate of the SA 43 is 55%. In the condition of third category, two potential stations 4 assemble the SAG 6, and the overlap rate of the SA 43 is 45%. In the condition of fourth category, two potential stations 4 assemble the SAG 6, but no overlapping between the SAs 43 and the overlap rate is 0%.

In the disclosure, the planning system 1 is configured to generate a plurality of different clustering result candidates through the aforementioned clustering mode. In the end, the planning system 1 is configured to take the clustering result candidate with the highest average overlap rate or the average overlap rate reaching the preset threshold value to be final clustering result.

As shown in FIG. 9, the planning system 1 is configured to group all of the potential stations 4 in the target area 4 into five SAGs 6, and the five SAGs 6 may reach the highest overlap rate of the SAs 43 or reach the threshold value preset by the planner or deployer.

The detail of the hierarchical clustering algorithm is omitted here for brevity. Apart from the hierarchical clustering algorithm, in some other embodiments, K-means algorithm, density based spatial clustering of applications with noise (DBSCAN) algorithm, etc., may also be used to cluster the potential stations 4, here is not intended to be limiting.

As describes above, the main object of the disclosure is to select the operating stations satisfied with the requirement from the planner or deployer and having highest utilization efficiency from the potential stations 4. In other words, the number of the operating stations is less than the number of the potential stations 4. Therefore, the planning method of the disclosure may be used to group the potential stations 4 with higher overlap rate of SAs 43 into the same SAG 6 to conclude the potential stations 4 complementary or competing with each other in each area. If the planning system 1 is configured to select the operating station from each SAG 6, the operating stations being selected may be guaranteed of providing better utilization efficiency (detailed as follows).

Referring back to FIG. 4, after the step S304, the SAG generating module 112 is configured to further compute the target object number covered by each SAG 6 according to the target-object distribution data (step S306). Specifically, the SAG generating module 112 is configured to compute the SAs 43 of all potential stations 4 in each SAG 6, and compute the target object number being covered totally by the SAs 43. When the target object number being covered is higher, that indicates the SAG 6 needs to be deployed with more operating stations.

For example, if the planning method of the disclosure is used on the land (for example, planning the operating station for the electric vehicle), the target-object distribution data may be the population distribution data. In the step S306, the SAG generating module 112 may be configured to calculate the population covered by each SAG 6 according to the population distribution data. Similarly, when the population being covered is higher, that indicates the SAG 6 needs to be deployed with more operating stations.

The aforementioned description is part of the embodiments of the disclosure, here is not intended to be limiting.

As described above, in the step S306, the SAG generating module 112 is configured to compute the target object number covered by each SAG 6. In some embodiments, after the target object number covered by each SAG 6 is computed, the SAG generating module 112 may be configured to remove the target area, in which the target object is non-present, from each SAG 6 according to the target-object distribution data. By the aforementioned technical feature, the disclosure may make the target object number and the practical covering area of each SAG 6 be more consistent to further increase the accuracy of following computation result.

Taking the application on the land as an example, the target-object distribution data may be the population distribution data, the SAG generating module 112 may be configured to remove the uninhabited area (for example, river, airport, etc.) from each SAG 6 according to the population distribution data to increase the accuracy of following computation result.

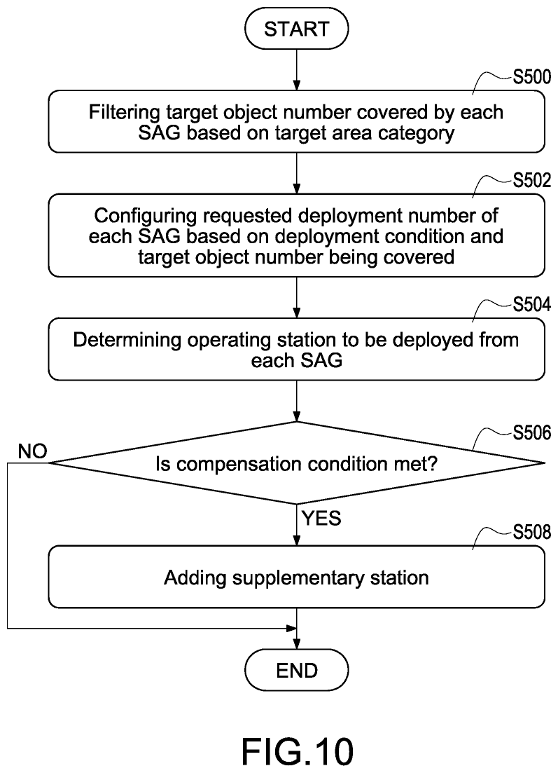

Please refer to FIG. 1 to FIG. 4 and FIG. 10, FIG. 10 is a flowchart of selecting the station of the disclosure in accordance with some embodiments. FIG. 10 is used for specifying the station selecting procedure (step S50) in FIG. 2. After the target object number covered by each SAG 6 is computed, the planning system 1 is configured to further compute the proper requested deployment number in each SAG 6 through the station selection module 113.

It is worth mentioning that before calculating the requested deployment number of each SAG 6, the station selection module 113 may be configured to receive a target area category set by the planner or deployer in advance and filter the target object number covered by each SAG 6 based on the target area category (step S500).

Taking the application on the land as an example, the target area category may be the target land use category. If the target client of the planner or deployer for deploying the charging station/battery station of the electric vehicle is the delivery business, the target land use category may be configured to be the building land. If the SA 43 of the first SAG covers the building land and agricultural land, the station selection module 113 may be configured to filter out the population on the agricultural land from the first SAG in step S500 based on the efficiency consideration, and to reserve the population on the building land. In contrary, if the target client of the deployment is agriculture, the planner or deployer may set the target land use category to be agricultural land, the station selection module 113 may be configured to filter out the population on the building land from the first SAG in the step S500, and to reserve the population on the agricultural land, and so forth.

The aforementioned description is part of the embodiments of the disclosure, here is not intended to be limiting.

On the other hand, in some other embodiments, the planner or deployer may not set the target client (that is, the target area category is not set), and thus the step S500 is not required.

Further, the station selection module 113 is configured to set the requested deployment number of each SAG 6 based on the deployment condition given by the planner or deployer and the target object number covered by each SAG 6 (step S502). The requested deployment number of each SAG 6 is an integer greater than or equal to zero.

Specifically, the planning method of the disclosure is used to determine the requested deployment number based on the target object number. Therefore, when the target object number being covered is less, the requested deployment number of part of the SAGs 6 may be zero.

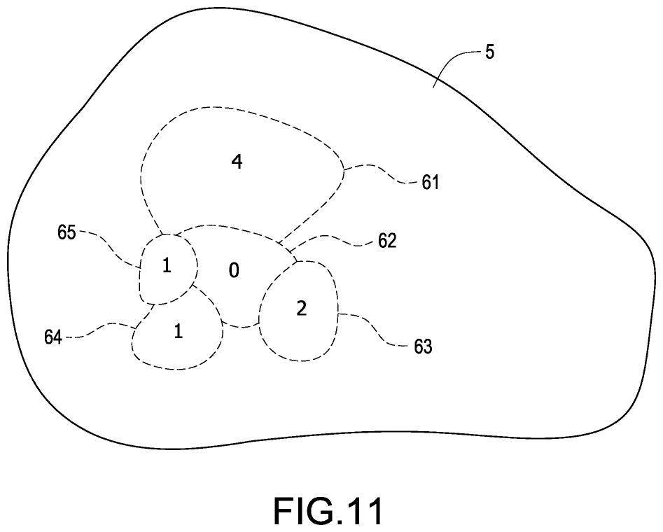

Please refer to FIG. 11, which is a schematic diagram of the station number of the disclosure in accordance with some embodiments. In the step S502, the station selection module 113 is configured to compute the requested deployment number based on the target object number covered by each SAG 6, the requested deployment number of the SAG 6 is greater when the target object number being covered is greater, and that is not related to the size of the SA 43 of each SAG 6.

In the embodiment of FIG. 11, the requested deployment number of the first SAG 61 is four stations, the requested deployment number of the second SAG 62 is zero station, the requested deployment number of the third SAG 63 is two stations, the requested deployment number of the fourth SAG 64 is one station, and the requested deployment number of the fifth SAG 65 is one station. The SA of the second SAG 62 is greater than that of the third SAG 63, the fourth SAG 64, and the fifth SAG 65, but the target object number being covered is too less, thereby the requested deployment number being zero.

Referring back to FIG. 10, in some embodiments, the deployment condition is a required total station number preset by the planner or deployer. That is, the number of the operating station that the planning system 1 needs to select from the potential stations 4. In some embodiments, the station selection module 113 may be configured to compute the requested deployment number of each SAG 6 based on formula (3) as below.

$$the requested deployment number = \frac{\begin{matrix}the target objected number being filtered in each SAG \times \\ the required total station number\end{matrix}}{\begin{matrix}a total number of the target object number \\ covered by all of the SAGs\end{matrix}} . \qquad ( 3 )$$

As described above, under the condition of the total number of the target object in the target area 5 being known and the required total station number being fixed, the requested deployment number is greater when the target object number covered by the SAG 6 (or the filtered target object number) is greater.

In some other embodiments, the deployment condition is the coverage rate of target object number covered by each SAG 6 (or the filtered target object number) to the total number of the target object covered by the SAs 43 of all potential stations 4. In some embodiments, in the step S502, the station selection module 113 is configured to iteratively compute the requested deployment number of each SAG 6, and the SA 43 of each SAG 6 formed after the station being deployed reaches the highest coverage rate. In some embodiments, the planner or deployer does not need to configure the required total station number, and the planning system 1 may be configured to automatically calculate the total number of the operating stations according to the coverage rate.

After the step S502, the station selection module 113 may be configured to further determine the operating station to be deployed from the potential stations 4 in each SAG 6 (step S504). The number of the operating station of each SAG 6 is the same with the number of the requested deployment number calculated in the step S502. In other words, the number of the operating station in the SAG 6 has the possibility of being zero.

In some embodiments, in the step S504, the station selection module 113 is configured to perform iterative computation to each SAG 6. Specifically, under the condition of the requested deployment number being non-zero, the station selection module 113 is configured to perform the iterative computation to the potential stations 4 in the SAGs 6 to make the SAs 43 of one or a plurality of operating stations being determined cover the most target object number.

For example, if the SAG 6 includes ten potential stations 4 and the requested deployment number is one, in the step S504, the station selection module 113 is configured to select the potential station 4 covering the most target object number to be the operating station of the SAG 6. If the requested deployment number of the SAG 6 is two, in the step S504, the station selection module 113 is configured to perform iterative computation to the ten potential stations 4 to select two potential stations 4, which cover the most target object number after the SAs 43 thereof being summed, to be the operating station of the SAG 6. Further, in the step S504, the station selection module 113 is configured to perform the iterative computation to each SAG 6 to select the operating stations in each SAG 6.

As described above, some of the SAGs 6 may cover less target object number, thereby the requested deployment number being zero. In that condition, the planner or deployer may optimize the SAGs 6 based on the practical requirement.

As shown in FIG. 1, the planning system 1 of the disclosure may further include a station compensation module 114. Similar with the other modules 111-113, the station compensation module 114 may be a software module or a hardware module, here is not intended to be limiting.

In some embodiments, after the operating stations are selected, the station compensation module 114 may be configured to determine whether the compensation condition preset by the planner or deployer is fulfilled (step S506) and add at least one supplementary station to the target area 5 when the compensation condition is fulfilled (step S508). In some embodiments, the supplementary station is being selected from the potential stations 4 in the target area 5 and is not overlapped with the operating stations selected in the step S504.

Taking the planning system 1 being applied on the land to plan the supplementary station of the charging station/battery station of the electric vehicle as an example, the compensation condition may be that no operating station is located in any administrative district of the target district. That is, the station compensation module 114 is configured to determine that the compensation condition is met when no operating station is located in any administrative district (for example, any administrative district of Taipei City in Taiwan) of the target district. As a result, in the step S508, the station compensation module 114 is configured to add a supplementary station to the administrative district without any operating station to make all administrative districts in the target district at least have one operating station or supplementary station.

It is worth mentioning that, in the step S508, the station compensation module 114 may be configured to select the potential station 4 with the largest SA 43 to be the supplementary station for the administrative district having no operating station. The aforementioned description is part of the embodiments of the disclosure, here is not intended to be limiting.

Some of the areas with less target object number may also be given consideration through the additional deployment of the supplementary station without over-influencing the average service efficiency of the operating stations.

The planning system 1 and planning method of the disclosure is used to automatically select a plurality of operating stations from all of the potential stations in the target area to make the number of the operating stations satisfy the budget requirement of the planner or deployer, and the estimated SA formed by the operating stations covers the most target object number. As a result, the disclosure facilitates utilizing the operating stations for the users.

Taking the planning system 1 and planning method being applied to plan the charging station/battery station of the electric vehicle as an example, the disclosure may be advantageous for the charging/replacing battery needs of the users of the electric vehicles, and further facilitate universalizing the electric transportation.

While this disclosure has been described by means of specific embodiments, numerous modifications and variations may be made thereto by those skilled in the art without departing from the scope and spirit of this disclosure set forth in the claims.

What is claimed is:

1. A planning method of deploying an operating station, used to plan a plurality of operating stations in a target area, the method comprising:
a) obtaining station information of the plurality of potential stations;
b) obtaining transportation network data, wherein the transportation network data includes a plurality of drivable routes around each potential station;
c) obtaining target-object distribution data of the target area;
d) computing a shortest route between the potential stations according to the station information and the transportation network data;
e) computing a service area (SA) of each potential station according to an evaluation condition;
f) grouping the potential stations into a plurality of service area groups (SAGs) based on the plurality of shortest routes and the plurality of SAs, wherein each SAG comprises one of the potential station or a plurality of different potential stations;
g) computing a target object number covered by each SAG according to the target-object distribution data; and
h) determining a requested deployment number of each SAG based on a deployment condition and the plurality of target object numbers, wherein the requested deployment number is an integer greater than or equal to zero.

2. The planning method according to claim 1, wherein the evaluation condition is a radius, the e) further comprises: using each potential station as a center, and planning a full circle based on the center and the radius to be the SA of each potential station.

3. The planning method according to claim 1, wherein the evaluation condition is a moving distance or a moving time, the e) further comprises: computing a boundary position arrived by departing from each potential station and moving along each drivable route for the moving distance or the moving time, and generating the SA of each potential station according to the plurality of boundary positions by a convex hull computation.

4. The planning method according to claim 1, wherein the f) further comprises: executing a clustering algorithm based on the shortest routes and the SAs to group the potential stations into a plurality of SAGs, wherein an average overlapping rate of the SAs of the potential stations in each SAG is a highest one, or greater than or equal to a preset threshold value.

5. The planning method according to claim 1, further comprising g1) after the g), the g1) comprising: deleting any target area from each SAG where the target area has no target object according to the target-object distribution data.

6. The planning method according to claim 1, further comprising: a1) obtaining a land use data, wherein the land use data records multiple area categories in the target area.

7. The planning method according to claim 6, further comprising h1) before the h), the h1) comprising: filtering the target object number covered by each SAG based on one or multiple target area categories.

8. The planning method according to claim 7, wherein the deployment condition is a required total station number, and the h) further comprises: computing the requested deployment number of each SAG through formula (1)
$$the requested deployment number = \frac{\begin{matrix}the target objected number being filtered in each SAG \times \\ the required total station number\end{matrix}}{\begin{matrix}a total number of the target object number \\ covered by all of the SAGs\end{matrix}} . \qquad ( 1 )$$

9. The planning method according to claim 7, wherein the deployment condition is a coverage rate, that is a ratio of the target object number being filtered in each SAG to a total number of the target object covered by the SAs of the potential stations, the h) further comprises: iteratively computing the requested deployment number of each SAG, wherein the SA formed after each SAG being deployed reaches a highest coverage rate.

10. The planning method according to claim 1, further comprising:
i) determining the operating stations from the potential stations of each SAG, wherein the number of the operating stations of each SAG is greater than or equal to the number of the requested deployment number.

11. The planning method according to claim 10, wherein the i) further comprises: iteratively computing the potential stations of each SAG to set the SA of one or multiple operating stations being determined cover most of the target object number.

12. The planning method according to claim 10, further comprising:
j) after the i), determining whether a compensation condition is met;
k) when the compensation condition is met, adding at least one supplementary station to the target area, wherein the supplementary station is non-overlapped with the operating station determined in the i).

13. The planning method according to claim 12, wherein the target area is a target district, the target object number is the population of the target district, and the j) further comprises: when no operating station exists in any one administrative district in the target district, determining that the compensation condition is met; and the k) further comprises: setting every administrative district in the target district comprise at least one operating station or supplementary station.
